(19) United States
(12) Patent Application Publication
(10) Pub. No.: US 2024/0218527 A1
(43) Pub. Date: Jul. 4, 2024

(54) WATER ELECTROLYSIS SYSTEM HAVING EXCELLENT DURABILITY AND METHOD OF OPERATING THE SAME

(71) Applicant: ACROLABS INC., Seongnam-si (KR)

(72) Inventors: Ho Suk Kim, Seongnam-si (KR); Su Young Kim, Seongnam-si (KR)

(73) Assignee: ACROLABS INC., Seongnam-si (KR)

(21) Appl. No.: 18/543,312

(22) Filed: Dec. 18, 2023

(30) Foreign Application Priority Data
Dec. 27, 2022 (KR) 10-2022-0185311

(51) Int. Cl. C25B 1/04; C25B 9/65; C25B 9/67; C25B 9/70; C25B 15/08

(52) U.S. Cl. CPC C25B 1/04; C25B 9/65; C25B 9/67; C25B 9/70; C25B 15/083; C25B 15/085; C25B 15/087

(57) ABSTRACT

A water electrolysis system including a water electrolysis stack having a structure where a plurality of unit cells and a separator plate are stacked and produces hydrogen and oxygen, a variable current power supplying supplies electrical energy, an electrolyte circulation line through which an electrolyte supplied to the water electrolysis stack circulates, a first electrolyte tank being provided on the electrolyte circulation line and is provided with a heating device, a first bypass line that branches off from the electrolyte circulation line at a first point located at a front end of the first electrolyte tank in a flow direction of an electrolyte, bypasses the first electrolyte tank, and is joined with the electrolyte circulation line at a second point located at a rear end of the first electrolyte tank, and a second electrolyte tank that is provided on the first bypass line, and a method of operating the same.

### CROSS-REFERENCE TO RELATED APPLICATION

This application claims priority to and the benefit of Korean Patent Application No. 10-2022-0185311, filed on Dec. 27, 2022, the disclosure of which is incorporated herein by reference in its entirety.

### BACKGROUND

### 1. Field of the Invention

The present invention relates to a water electrolysis system having excellent durability and a method of operating the same.

### 2. Discussion of Related Art

Recently, as the supply of renewable energy sources, such as solar and wind power, and hydrogen fuel cell vehicles and fuel cells for power generation using hydrogen is expanding and the use of renewable energy sources is increasing and hydrogen is used as an energy carrier in terms of energy storage, the importance of a durable water electrolysis system technology is emerging.

Technologies for producing hydrogen using water electrolysis include acid and alkaline water electrolysis technology, proton exchange membrane (PEM) water electrolysis technology, and anion exchange membrane (AEM) water electrolysis technology.

A reaction in which water is decomposed into hydrogen and oxygen is a thermodynamically involuntary endothermic reaction, and an electrochemical reaction using external electrical energy occurs. In a low-temperature water electrolysis system, which usually operates at 100° C. or lower, a water electrolysis reaction is occurred by supplied thermal energy and electrical energy, and at this time, theoretically, based on high calorific value, a cell voltage of a water electrolysis stack requires an overvoltage of 1.48 V or more. In order to increase the efficiency of a water electrolysis system, it is important to reduce the electrical energy required for the water electrolysis reaction.

The operation of water electrolysis system is performed by repeatedly starting and stopping in connection with renewable energy or grid power. During the period when electrical energy is not supplied to the water electrolysis stack, that is, during the period when no current flows, the water electrolysis stack can be degraded by various factors as follows.

A reverse current that occurs when no current flows inside the water electrolysis stack can cause an oxidation reaction at a cathode where a hydrogen generation reaction occurs, resulting in permanent damage to a catalyst electrode, which can lead to various problems such as catalyst elution and degradation of stack performance. In addition, when the water electrolysis system is stopped, the hydrogen and oxygen in the form of fine bubbles remaining on the catalyst electrode of a water electrolysis stack cell can cause a thermodynamically voluntary water synthesis reaction, which can cause fatal and irreversible damage to an electrolyte membrane and an adjacent catalyst electrode. The irreversible damage can result in reduced performance and durability of the water electrolysis stack.

Patent Document 1 is known as a technology for preventing a reverse current that occurs when a water electrolysis system starts and stops. Patent Document 1 proposes a water electrolysis system including a water electrolysis stack that includes a plurality of membrane-electrode assemblies and generates hydrogen and oxygen by electrolyzing an alkaline aqueous solution supplied from an electrolyte tank, a voltage supply unit that outputs a voltage required for electrolysis to the water electrolysis stack, a voltage consumption device that is connected to the water electrolysis stack when the water electrolysis stack is in a no-load state and consumes and removes a residual voltage of the water electrolysis stack, and a control unit that controls the operation of the water electrolysis stack, the voltage supply unit, and the voltage consumption device, wherein the voltage consumption device includes an auxiliary heater installed in the electrolyte tank.

However, Patent Document 1 does not provide a method to fundamentally prevent a reverse current of the water electrolysis stack, which frequently occurs during the startup and stop stages of operating the water electrolysis system.

### RELATED ART

### Patent Documentation

(Patent Document) Korean Patent Registered No. 1724060

### SUMMARY OF THE INVENTION

The present invention is directed to providing a water electrolysis system that enables stable operation and has improved durability and a method of operating the same.

According to an aspect of the present invention, there is provided a water electrolysis system including: a water electrolysis stack that has a structure in which a plurality of unit cells and a separator plate are stacked and produces hydrogen and oxygen through a water electrolysis reaction; a variable current power supply that supplies electrical energy required for operation of the water electrolysis stack; an electrolyte circulation line through which an electrolyte supplied to the water electrolysis stack circulates; a first electrolyte tank that is provided on the electrolyte circulation line to store a high-temperature electrolyte and provided with a heating device; a first bypass line that branches off from the electrolyte circulation line at a first point located at a front end of the first electrolyte tank in a flow direction of an electrolyte, bypasses the first electrolyte tank, and is joined with the electrolyte circulation line at a second point located at a rear end of the first electrolyte tank; and a second electrolyte tank that is provided on the first bypass line and stores a low-temperature electrolyte.

The water electrolysis system may further include a first three-way valve and a second three-way valve respectively provided at the first and second points to selectively flow the electrolyte into the electrolyte circulation line or the first bypass line.

The water electrolysis system may further include a second bypass line that branches off from the electrolyte circulation line at a third point located in front of the first point in the flow direction of the electrolyte and is joined with the electrolyte circulation line at a fourth point located between the first point and the third point, and a heat exchanger that is provided on the second bypass line and recovers heat from the electrolyte to cooling water.

The water electrolysis system may further include a third three-way valve provided at the third point to selectively flow the electrolyte into the electrolyte circulation line or the second bypass line.

The water electrolysis system may further include a cell voltage reducer that reduces a cell voltage when the water electrolysis system is stopped.

The water electrolysis system may further include a separator tank that separates moisture from a hydrogen-containing gas discharged from the water electrolysis stack, an oxygen remover that removes oxygen mixed with the moisture-separated hydrogen-containing gas, a temperature sensor that detects a temperature inside the oxygen remover, and a dehumidifier that removes residual moisture from hydrogen-containing gas from which the oxygen is removed.

According to another aspect of the present invention, there is provided a method of operating the water electrolysis system including flowing a predetermined current through the variable current power supply when the water electrolysis system is stopped, operating the first and second three-way valves while maintaining a voltage, which is applied to the water electrolysis stack, higher than a theoretical electrolysis voltage of the unit cell, and supplying a low-temperature electrolyte stored in the second electrolyte tank to the water electrolysis stack.

When the water electrolysis system is stopped, a voltage applied to the water electrolysis stack may be in a range of 1.50 to 1.65 V.

When the water electrolysis system is stopped, the third three-way valve may be operated to supply an electrolyte discharged from the water electrolysis stack to the heat exchanger.

The method further may include cutting off power supplied by the variable current power supply after a temperature of the electrolyte discharged from the water electrolysis stack decreases to a predetermined level or lower by supplying the low-temperature electrolyte, and reducing the cell voltage by the cell voltage reducer.

A temperature at which the power supply is cut off may be 40° C. or lower.

According to still another aspect of the present invention, there is provided a method of operating the water electrolysis system that includes detecting the temperature inside the oxygen remover using the temperature sensor when the water electrolysis system is stopped and detecting a cross-leak of the water electrolysis stack in real time.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic conceptual diagram for explaining a water electrolysis system according to an embodiment of the present invention;

FIG. 2 is a diagram showing a flow of an electrolyte when a water electrolysis system is started in a method of operating a water electrolysis system according to an embodiment of the present invention;

FIG. 3 is a diagram showing a flow of an electrolyte when a temperature of an electrolyte increases excessively during normal operation of a water electrolysis system in a method of operating a water electrolysis system according to an embodiment of the present invention; and

FIG. 4 is a diagram showing a flow of an electrolyte when a water electrolysis system is stopped in a method of operating a water electrolysis system according to an embodiment of the present invention.

### DETAILED DESCRIPTION OF EXEMPLARY EMBODIMENTS

Prior to the detailed description of the present invention, terms or words used in the specification and claims described below should not be construed as being limited to usual or dictionary meanings and should be interpreted as a meaning and concept consistent with the technical idea of the present disclosure based on the principle that the inventor can appropriately define the concept of terms to explain his/her invention in the best way. The embodiments described in the present specification and the configurations shown in the accompanying drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

Throughout the specification, when a part is said to be “connected” to another part, this includes not only the case where it is “directly connected,” but also the case where it is “indirectly connected” with still another component therebetween.

Throughout the specification, when a part “includes” a certain component, this means that it may further include other components rather than excluding other components, unless specifically stated to the contrary. Additionally, throughout the specification, the singular form also includes the plural form unless otherwise specified.

Hereinafter, exemplary embodiments of the present invention will be described in detail with reference to the accompanying drawings. Detailed descriptions of well-known functions and configurations that may obscure the gist of the present invention have been omitted. For the same reason, in the accompanying drawings, some components are exaggerated, omitted, or schematically shown, and the size of each component does not entirely reflect the actual size.

### Water Electrolysis System

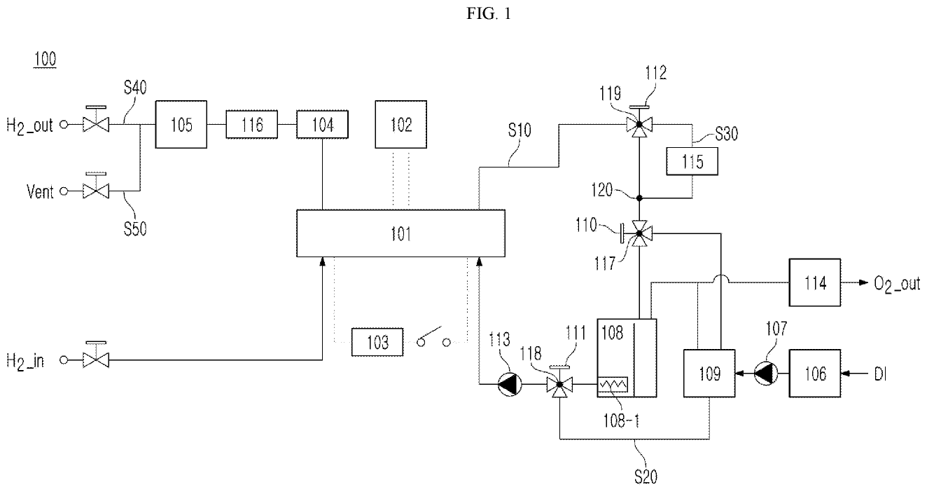

FIG. 1 is a schematic conceptual diagram for explaining a water electrolysis system according to an embodiment of the present invention.

A water electrolysis stack 101 is formed to have a structure in which a plurality of unit cells (membrane electrode assembly) and a separator plate are stacked, and receives external power to electrolyze water to produce hydrogen and oxygen. In normal operation, a voltage of approximately 1.7 V to 2.1 V is applied to each unit cell.

The unit cell may include an anion exchange membrane, an anode formed in close contact with one side of the anion exchange membrane, and a cathode formed in close contact with the other side of the anion exchange membrane.

At the cathode, electrons supplied from an external power source react with water (H₂O) to generate hydrogen gas and OH⁻, as shown in Chemical Equation 1 below, the OH⁻ may move to the anode through an ion exchange membrane (diaphragm) to generate water (H₂O) and oxygen gas as shown in Chemical Equation 2 below.

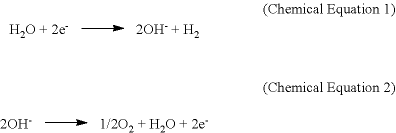

The separator plate connects two neighboring unit cells in series and supports the two neighboring unit cells firmly. One separator plate may be placed between two neighboring unit cells and is called a bipolar plate. The separator plate may have a channel formed to supply an electrolyte to the unit cell.

A variable current power supply 102 supplies the electrical energy required to operate the water electrolysis stack 101. When the water electrolysis system 100 is stopped and the water electrolysis stack 101 is in a no-load state, a residual voltage (current) accelerates the degradation of a catalyst on the anode and the cathode, as well as the anion exchange membrane. Therefore, the long-term performance of the water electrolysis stack 101 may be adversely affected. The variable current power supply 102 allows a predetermined current to flow through the water electrolysis stack 101 even when the water electrolysis system 100 is stopped, which maintains a voltage range of 1.50 to 1.65 V for each unit cell, thereby suppressing an occurrence of a reverse current.

A cell voltage reducer 103 is electrically connected to the water electrolysis stack 101 and detects a voltage applied to the water electrolysis stack 101 in real time, and can prevent the irreversible degradation of the water electrolysis stack 101 by removing a residual voltage when a voltage applied to the water electrolysis stack 101 is less than a threshold in a stopped state of the water electrolysis system 100, but is not limited thereto.

The electrolyte may be an alkaline aqueous solution in which salts such as potassium hydroxide (KOH) and potassium carbonate (K₂CO₃) are dissolved in deionized water, but is not limited thereto. The alkaline aqueous solution may be supplied to both the cathode and the anode, or only to the anode. In the latter case, dry hydrogen is produced at the cathode.

Hydrogen gas generated at the cathode may pass through a cathode separator tank 104 and a dehumidifier 105 to be discharged to the outside of the water electrolysis system 100 through a hydrogen gas discharge pipe S40.

Hydrogen gas generated at the cathode contains some moisture that has passed through the anion exchange membrane, and may also contain impurities due to device degradation. The moisture and impurities may be separated from hydrogen in the gas phase and removed in the cathode separator tank 104.

A trace amount of moisture may remain in the hydrogen gas that has passed through the cathode separator tank 104, and the trace amount of moisture may be removed by being adsorbed on a regenerative adsorbent provided inside the dehumidifier 105. Moisture adsorbed by the regenerative adsorbent may be discharged to the outside of the water electrolysis system 100 through a water vapor discharge pipe S50 branched off from the hydrogen gas discharge pipe S40 through an adsorbent regeneration process.

Meanwhile, in an operation or stop process of the water electrolysis system 100, a so-called cross-leak, in which oxygen on the anode side passes through the anion exchange membrane and leaks to the cathode side, may occur. When the cross-leak occurs, hydrogen production efficiency decreases, and thus this degradation needs to be prevented. For this purpose, an oxygen remover 116 may be provided between the cathode separator tank 104 and the dehumidifier 105 to remove oxygen gas mixed with hydrogen gas, but is not limited thereto.

Meanwhile, the oxygen remover 116 is provided with a temperature sensor to detect the temperature inside the oxygen remover 116, and through this, the cross-leak can be detected in real time to determine whether there is an abnormality in the water electrolysis system 100, but is not limited thereto.

At least a portion of the hydrogen gas discharged through the hydrogen gas discharge pipe S40 may be recirculated to the cathode, but is not limited thereto. The anion exchange membrane has low water permeability and operates efficiently in a wet state. When a temperature inside the cathode increases, the anion exchange membrane may be dry and its operating efficiency may decrease, and thus the temperature inside the cathode needs to be maintained within a predetermined range. When a hydrogen gas recycling process is performed, the recycled hydrogen gas serves as a cooling medium, and accordingly, electrolysis efficiency can be greatly improved even without a separate cooling system for a unit cell.

FIG. 1 illustrates a water electrolysis system in which an electrolyte is supplied only to an anode.

The electrolyte is circulated by an electrolyte pump through an electrolyte circulation line S10 or a first bypass line S20, and is stored in a first electrolyte tank 108 provided on the electrolyte circulation line S10 or a second electrolyte tank 109 provided on the first bypass line S20.

Oxygen gas generated at the anode is supplied to an anode separator tank 114 through the first electrolyte tank 108 along the electrolyte circulation line S10 or through the second electrolyte tank 109 along the first bypass line S20, and is separated from moisture and impurities in the anode separator tank 114 so that the oxygen in gas phase may be discharged to the outside of the water electrolysis system.

A high-temperature electrolyte is stored in the first electrolyte tank 108, and the first electrolyte tank 108 may be provided with a heating device 108-1 for heating and maintaining the temperature of the electrolyte to increase the temperature of the electrolyte.

A low-temperature electrolyte is stored in the second electrolyte tank 109, and the second electrolyte tank 109 may be supplied with deionized water stored in a deionized water tank 106 by a deionized water pump 107 to lower the temperature of the electrolyte.

The first bypass line S20 branches off from the electrolyte circulation line S10 at a first point 117 located at a front end of the first electrolyte tank 108 based on a flow direction of an electrolyte, and may bypass the first electrolyte tank 108 and be joined with the electrolyte circulation line at a second point 118 located at a rear end of the first electrolyte tank 108.

The first point 117 and the second point 118 may be respectively provided at first and second three-way valves 110 and 111 to selectively flow an electrolyte in the direction of the first electrolyte tank 108 or the second electrolyte tank 109, but are not limited thereto.

In order to operate the water electrolysis stack stably when the water electrolysis system starts, it is necessary to rapidly increase the temperature of the electrolyte. Conversely, in order to minimize an irreversible degradation reaction that occurs in the water electrolysis stack when the water electrolysis system is stopped, it is necessary to drastically lower the temperature of the electrolyte and shorten the cooling time of the water electrolysis stack. When all of the electrolyte required to operate the water electrolysis system is heated or cooled, excessive costs are incurred in providing the necessary heating and cooling equipment, and the power consumption of the electrolyte pump can increase excessively.

In the present invention, the high-temperature electrolyte and the low-temperature electrolyte may be selectively used according to each situation, resulting in advantages of significantly shortening a start-up time of the water electrolysis system and dramatically improving the durability of the water electrolysis system while reducing the installation costs of heating and cooling equipment.

A second bypass line S30 that branches off from the electrolyte circulation line S10 (a third point, 119) at a front end of the first point 117 based on the flow direction of the electrolyte and is joined with the electrolyte circulation line through a heat exchanger 115 (a fourth point, 120) may be provided. The electrolyte flows into one side of the heat exchanger 115, and cooling water flows into the other side, and thus heat may be recovered from the electrolyte to the cooling water.

The third point 119 may be provided with a third three-way valve 112 that selectively flows the electrolyte into the electrolyte circulation line S10 or the second bypass line S30, but is not limited thereto.

During normal operation of the water electrolysis system, the temperature of the electrolyte may increase excessively due to overvoltage of the unit cell. In this case, it is necessary to cool the electrolyte to keep a constant temperature of the water electrolysis stack. In addition, in order to minimize an irreversible degradation reaction that occurs in the water electrolysis stack when the water electrolysis system is stopped, it is necessary to cool the electrolyte whose temperature has increased while passing through the water electrolysis stack.

In the present invention, the water electrolysis system may be operated more stably by configuring the electrolyte to pass or not pass through the heat exchanger according to each situation.

### Method of Operating a Water Electrolysis System

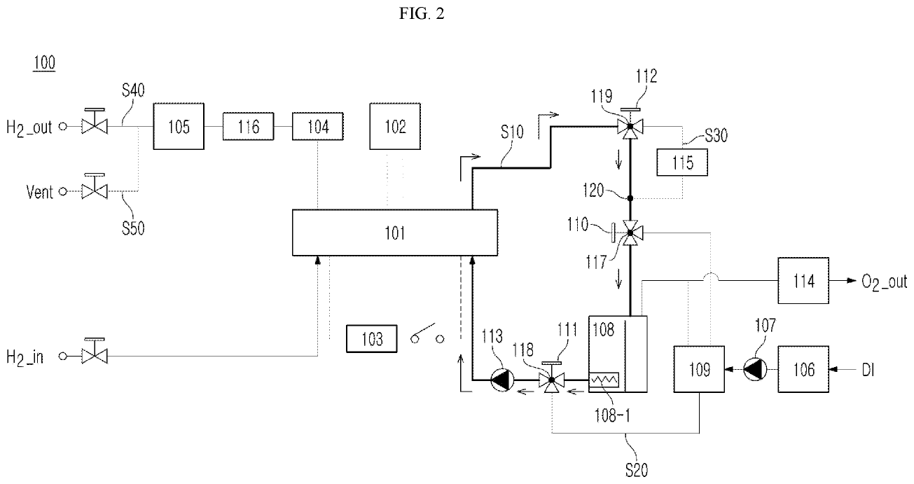

FIG. 2 is a diagram showing a flow of an electrolyte when a water electrolysis system is started in a method of operating a water electrolysis system according to an embodiment of the present invention.

When the water electrolysis system 100 starts, the water electrolysis system operates at a temperature of 100° C. or lower, which is a stable operating temperature of the water electrolysis stack 101, for example, in a range of 40 to 80° C. Therefore, a high-temperature electrolyte in the first electrolyte tank 108 provided with the heating device 108-1 is used, and the third three-way valve 112 is adjusted so that the electrolyte does not pass through the heat exchanger 115 to increase the temperature of the electrolysis stack 101.

When the temperature of the water electrolysis stack 101 increases to a predetermined operating temperature, the water electrolysis system 100 is normally operated through current control (constant current) of the variable current power supply 102 to produce hydrogen and oxygen.

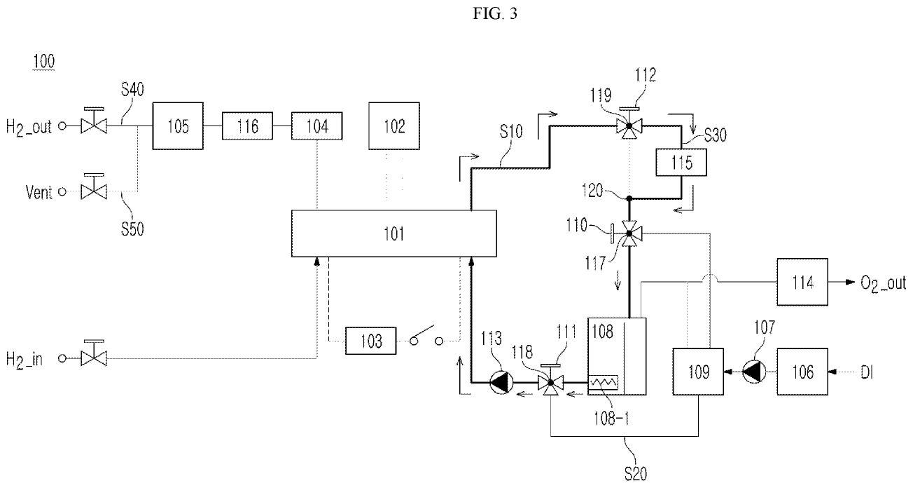

FIG. 3 is a diagram showing a flow of an electrolyte when a temperature of an electrolyte increases excessively during normal operation of a water electrolysis system in a method of operating a water electrolysis system according to an embodiment of the present invention.

When the temperature of the electrolyte increases excessively due to overvoltage of the unit cell during normal operation of the water electrolysis system 100, the third three-way valve 112 is controlled so that the electrolyte passes through the heat exchanger 115 to keep a constant operating temperature of the water electrolysis stack 101.

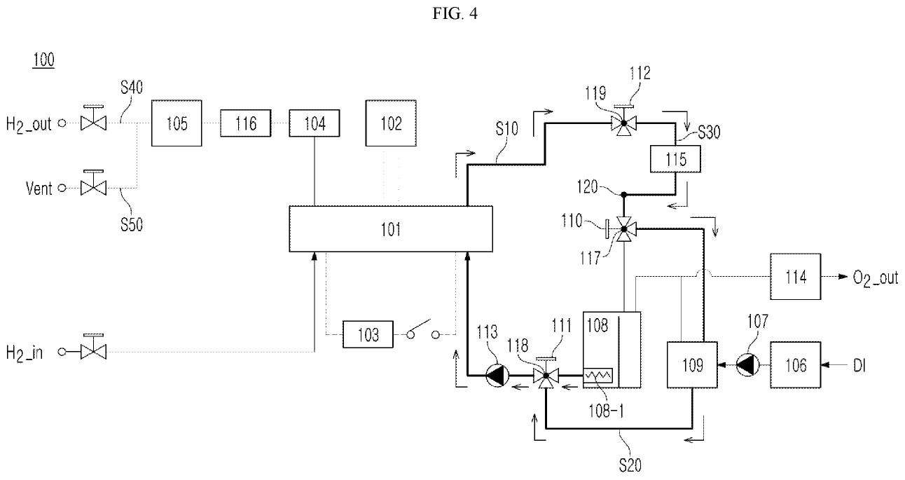

FIG. 4 is a diagram showing a flow of an electrolyte when a water electrolysis system is stopped in a method of operating a water electrolysis system according to an embodiment of the present invention.

When the water electrolysis system 100 is stopped, by flowing a predetermined current through the variable current power supply 102, operating the first and second three-way valves 110 and 111 while maintaining a voltage, which is applied to the water electrolysis stack 101, higher than a theoretical electrolysis voltage (1.23 V) of the unit cell, and supplying a low-temperature electrolyte stored in the second electrolyte tank 109 to the water electrolysis stack 101, the water electrolysis stack 101 cools rapidly.

When the water electrolysis system 100 stops, a voltage applied to the water electrolysis stack 101 may be in a range of 1.50 to 1.65 V, but is not limited thereto. In this case, a reverse current can be prevented from occurring in the unit cell in a no-load state.

Cooling of the water electrolysis stack by the low-temperature electrolyte may continue until the temperature of an electrolyte discharged from the water electrolysis stack 101 reaches a target temperature (e.g., 40° C. or lower), and the cooling time may be in a range of 5 to 10 minutes, but is not limited thereto.

In the present invention, when the water electrolysis system is stopped, the rapid cooling of the water electrolysis stack is achieved using the low-temperature electrolyte stored in the second electrolyte tank. Therefore, fine hydrogen and oxygen bubbles remaining on a catalyst electrode of the unit cell are quickly removed, and the degradation of the water electrolysis stack that may occur by reactions other than water electrolysis reaction can be prevented. Additionally, irreversible degradation reactions that may occur when the cooling time of the water electrolysis stack is prolonged can be minimized.

When the water electrolysis system 100 is stopped, the third three-way valve 112 may be operated so that the electrolyte discharged from the water electrolysis stack 101 passes through the heat exchanger 115, but is not limited thereto. Therefore, by allowing the electrolyte to pass through the heat exchanger 115 when the water electrolysis system 100 is stopped, the cooling time of the water electrolysis stack 101 can be further shortened.

When the water electrolysis system 100 is stopped and the temperature of the electrolyte discharged from the water electrolysis stack 101 reaches the target temperature by supplying the low-temperature electrolyte, the supply of power by the variable current power supply 102 may be cut off and a cell voltage may be reduced by the cell voltage reducer 103, but the present invention is not limited thereto. Therefore, by consuming and removing a residual voltage by the cell voltage reducer 103, the degradation of a catalyst on the anode and cathode, as well as an anion exchange membrane, can be prevented, thereby improving the lifetime and durability of the water electrolysis stack 101.

Meanwhile, in the operation process or the stop process of the water electrolysis system 100, a so-called cross-leak, in which oxygen on the anode side passes through the anion exchange membrane and leaks to the cathode side and oxygen gas mixes with hydrogen gas, may occur. When the cross-leak occurs, hydrogen production efficiency decreases, and thus this decrease needs to be prevented. For this purpose, an oxygen remover 116 may be provided between the cathode separator tank 104 and the dehumidifier 105 to remove oxygen gas mixed with hydrogen gas.

Meanwhile, the oxygen remover 116 is provided with a temperature sensor to detect the temperature inside the oxygen remover 116, and through this, the cross-leak can be detected in real time to determine whether there is an abnormality in the water electrolysis system 100.

According to the present invention, when a water electrolysis stack is in a no-load state, a reverse current can be prevented and degradation occurring between the electrolyte membrane and the catalyst electrode can be prevented by minimizing the cooling time of a unit cell of the water electrolysis stack.

In addition, according to the present invention, when a water electrolysis stack is in a no-load state, fatal and irreversible damage to an electrolyte membrane and an adjacent catalyst electrode caused by hydrogen and oxygen in the form of fine bubbles remaining on a catalyst electrode of the water electrolysis stack can be prevented, thereby improving the performance and durability of the water electrolysis stack.

However, the effects that can be achieved through the present invention are not limited to the above-described effects, and it should be understood to include all effects that can be inferred from the configuration described in the detailed description or claims of the specification.

The description of the present specification described above is for illustrative purposes, and those skilled in the art to which one aspect of the present specification pertains will be able to understand that the technical idea or essential features described in the specification can be easily transformed into another specific form without being changed. Therefore, the embodiments described above should be understood in all respects as illustrative and not restrictive. For example, each component described as a single-type may be implemented in a distributed manner, and similarly, components described as distributed may also be implemented in a combined form.

The scope of the present specification is indicated by the claims described below, and all changes or modified forms derived from the meaning and scope of the claims and their equivalent concepts should be construed as being included in the scope of the present specification.

What is claimed is:

1. A water electrolysis system comprising:
a water electrolysis stack that has a structure in which a plurality of unit cells and a separator plate are stacked and produces hydrogen and oxygen through a water electrolysis reaction;
a variable current power supply that supplies electrical energy required for operation of the water electrolysis stack;
an electrolyte circulation line through which an electrolyte supplied to the water electrolysis stack circulates;
a first electrolyte tank that is provided on the electrolyte circulation line to store a high-temperature electrolyte and provided with a heating device;
a first bypass line that branches off from the electrolyte circulation line at a first point located at a front end of the first electrolyte tank in a flow direction of an electrolyte, bypasses the first electrolyte tank, and is joined with the electrolyte circulation line at a second point located at a rear end of the first electrolyte tank; and
a second electrolyte tank that is provided on the first bypass line and stores a low-temperature electrolyte.

2. The water electrolysis system of claim 1, further comprising a first three-way valve and a second three-way valve respectively provided at the first and second points to selectively flow the electrolyte into the electrolyte circulation line or the first bypass line.

3. The water electrolysis system of claim 1, further comprising:
a second bypass line that branches off from the electrolyte circulation line at a third point located at a front end of the first point in the flow direction of the electrolyte, and is joined with the electrolyte circulation line at a fourth point located between the first point and the third point; and
a heat exchanger that is provided on the second bypass line and recovers heat from the electrolyte to cooling water.

4. The water electrolysis system of claim 3, further comprising a third three-way valve provided at the third point to selectively flow the electrolyte into the electrolyte circulation line or the second bypass line.

5. The water electrolysis system of claim 1, further comprising a cell voltage reducer that reduces a cell voltage when the water electrolysis system is stopped.

6. The water electrolysis system of claim 1, further comprising:
a separator tank that separates moisture from a hydrogen-containing gas discharged from the water electrolysis stack;
an oxygen remover that removes oxygen mixed with the moisture-separated hydrogen-containing gas;
a temperature sensor that detects a temperature inside the oxygen remover; and
a dehumidifier that removes residual moisture from hydrogen-containing gas from which the oxygen is removed.

7. A method of operating the water electrolysis system according to claim 1, comprising:
flowing a predetermined current through the variable current power supply when the water electrolysis system is stopped;
operating the first and second three-way valves while maintaining a voltage, which is applied to the water electrolysis stack, higher than a theoretical electrolysis voltage of the unit cell; and
supplying the low-temperature electrolyte stored in the second electrolyte tank to the water electrolysis stack.

8. The method of claim 7, wherein when the water electrolysis system is stopped, a voltage applied to the water electrolysis stack is in a range of 1.50 to 1.65 V.

9. The method of claim 7, wherein:
the water electrolysis system further includes a second bypass line that branches off from the electrolyte circulation line at a third point located at the front end of the first point in the flow direction of the electrolyte and is joined with the electrolyte circulation line at a fourth point located between the first point and the third point, a heat exchanger that is provided on the second bypass line and recovers heat from the electrolyte to cooling water, and a third three-way valve provided at the third point to selectively flow the electrolyte into the electrolyte circulation line or the second bypass line; and
when the water electrolysis system is stopped, the third three-way valve is operated to supply an electrolyte discharged from the water electrolysis stack to the heat exchanger.

10. The method of claim 7, wherein the water electrolysis system further includes a cell voltage reducer that reduces a cell voltage when the water electrolysis stack is stopped, and
the method further comprises cutting off power supplied by the variable current power supply after a temperature of the electrolyte discharged from the water electrolysis stack decreases to a predetermined level or lower by supplying the low-temperature electrolyte, and reducing the cell voltage by the cell voltage reducer.

11. The method of claim 10, wherein a temperature at which the supplied power is cut off is 40° C. or lower.

12. A method of operating the water electrolysis system according to claim 6, comprising:
detecting the temperature inside the oxygen remover using the temperature sensor when the water electrolysis system is stopped; and
detecting a cross-leak of the water electrolysis stack in real time.
